(19) United States
(12) Patent Application Publication
(10) Pub. No.: US 2018/0025094 A1
(43) Pub. Date: Jan. 25, 2018

(54) INCREASING PERFORMANCE OF IN-MEMORY DATABASES USING RE-ORDERED QUERY EXECUTION PLANS

(71) Applicant: SAP SE, Walldorf (DE)

(72) Inventor: Ahmad Hassan, Belfast (IE)

(21) Appl. No.: 15/214,082

(22) Filed: Jul. 19, 2016

(51) Int. Cl. G06F 17/30; G06F 12/0806

(52) U.S. Cl. CPC G06F 17/30979; G06F 12/0806; G06F 2212/1021; G06F 2212/608

(57) ABSTRACT

Implementations of the present disclosure include methods, systems, and computer-readable storage mediums for receiving a query from an application, providing a query execution plan (QEP) associated with the query, the QEP including a plurality of operators executed in a first order to provide a query result, one or more operators of the plurality of operators requiring input from computer-readable memory, determining an execution time for each operator in the plurality of operators, re-ordering at least one operator of the plurality of operators to provide a re-ordered QEP (rQEP) based on a respective execution time, the rQEP including the plurality of operators executed in a second order to provide the query result, and storing the rQEP in computer-readable memory.

### BACKGROUND

A business or other type of enterprise may operate enterprise systems to provide software functionality to customers and employees. An enterprise system may include back-end enterprise servers that host enterprise applications such as enterprise resource planning (ERP) systems, client-relationship management (CRM) systems, product lifecycle management (PLM) systems, supply chain management (SCM) systems, supplier relationship management (SRM) systems, and so forth. During the execution of an enterprise application, application data may be placed in or accessed from the main memory of the enterprise server, such that the application data is immediately accessible by processors of the enterprise server.

In-memory computing has been a driver in the design of enterprise applications in terms of functionality, real-time process management, and real-time decision making. Advances in processing and memory systems have triggered the transition of enterprise applications to in-memory database technology, where all desired data is kept in main memory for high throughput processing.

### SUMMARY

Implementations of the present disclosure include computer-implemented methods for using re-ordered query execution plans to increase performance in in-memory database systems. In some implementations, methods include actions of receiving a query from an application, providing a query execution plan (QEP) associated with the query, the QEP including a plurality of operators executed in a first order to provide a query result, one or more operators of the plurality of operators requiring input from computer-readable memory, determining an execution time for each operator in the plurality of operators, re-ordering at least one operator of the plurality of operators to provide a re-ordered QEP (rQEP) based on a respective execution time, the rQEP including the plurality of operators executed in a second order to provide the query result, and storing the rQEP in computer-readable memory.

These and other implementations may each optionally include one or more of the following features: re-ordering at least one operator includes: identifying an operator as a time-consuming operator, the operator providing an intermediate result that is provided as input to the at least one operator, and moving the at least one operator relative to the operator, such that a number of operators between the operator and the at least one operator is reduced; the at least one operator is moved relative to the operator, such that the number of operators between the operator and the at least one operator is reduced to zero; during execution of the QEP, the at least one operator receives input data from non-cache memory; during execution of the rQEP, the at least one operator receives input data from a cache; execution of the rQEP results in fewer cache misses than execution of the QEP; and actions further includes: receiving source code of the application, providing an instrumented application that includes the source code and instrumentation code, the instrumented application including at least one instruction for profiling the plurality of operators, executing the instrumented application to process the QEP to provide a profiling file, the profiling file indicating, for each operator in the plurality of operators, respective start times and end time, and, for each operator in the plurality of operators, determining a respective execution time based on a respective start time and a respective end time.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example memory access path.

FIG. 2 depicts an example architecture to profile query execution plans (QEPs) in accordance with implementations of the present disclosure.

FIG. 3 depicts an example process that can be executed in accordance with implementations such as those of the present disclosure.

FIG. 4 is a schematic illustration of example computer systems that may be employed for implementations such as those of the present disclosure.

Like reference symbols in the various drawings indicate like elements.

### DETAILED DESCRIPTION

Implementations of the present disclosure are generally directed to using re-ordered query execution plans (rQEPs) to increase performance in-memory database systems. In some implementations, actions can include receiving a query from an application, providing a query execution plan (QEP) associated with the query, the QEP including a plurality of operators executed in a first order to provide a query result, one or more operators of the plurality of operators requiring input from computer-readable memory, determining an execution time for each operator in the plurality of operators, re-ordering at least one operator of the plurality of operators to provide a re-ordered QEP (rQEP) based on a respective execution time, the rQEP including the plurality of operators executed in a second order to provide the query result, and storing the rQEP in computer-readable memory.

To provide context for implementations of the present disclosure, real-time data analytics aim at making knowledge available with sub-second and often sub-millisecond response time. For example, real-time enterprise resource planning (ERP) systems enable enterprises to view every change in the enterprise as soon as it happens, and can be a driver in the success of the enterprise. In some examples, real-time access to information helps in gaining competitive advantage through efficient and improved (e.g., more informed) decision making, product pricing, risk management, product life-cycle, customer feedback, customer engagement, brand development, product pricing, and reduced total cost of ownership (TCO). The growing volumes of enterprise data makes it challenging to achieve the target response times in real-time data analytics.

The advances in multi-core processing, caching and less expensive main memory has brought a major breakthrough in designing real-time enterprise systems. In-memory databases open doors for real-time analytics as it uses faster main-memory as a primary storage and bypass I/O disk delays in analytical data processing. Improvements in both hardware and in-memory databases have triggered the unification of both operational and analytical storage models together in a unified in-memory data store. For example, slower, disk-based memory is only required for persistent storage. This has a negligible impact on the throughput of in-memory databases, because persistence is moved from the critical path. Accordingly, in-memory databases enable real-time data analytics on unified data with minimal response times, because the data resides in main memory, which is an order of magnitude faster for accessing than traditional, disk-based memory.

Main memory may include one or more types of memory (e.g., DRAM, NVM) that communicates with one or more processors, e.g., CPU(s), over a memory bus. An in-memory database system may be contrasted with database management systems that employ a disk storage mechanism. In some examples, in-memory database systems may be faster than disk storage databases, because internal optimization algorithms may be simpler and execute fewer CPU instructions. In some examples, accessing data in an in-memory database system may reduce or eliminate seek time when querying the data, providing faster and more predictable performance than disk-storage databases. An in-memory database may include a row-oriented database, in which data is stored in any number of rows or records. An in-memory database may also include a column-oriented in-memory database, in which data tables are stored as sections of columns of data (rather than as rows of data). An example in-memory database system is HANA™, provided by SAP™ SE of Walldorf, Germany.

In view of the above context, and as described in further detail herein, implementations of the present disclosure are generally directed to using rQEPs to increase performance in in-memory database systems. More particularly, implementations of the present disclosure provide optimizations for cache-friendly query execution using rQEPs. Implementations provide a perceptive of in-memory databases in the context of running a database within caches with to achieve high locality.

In some implementations, improving the throughput of query execution engines can be achieved when the in-memory database runs within processor caches (even for large data sets), and utilizes cache data with higher efficiency. Implementations of the present disclosure provide for rQEPs, which enable more efficient use of cached data, before the cached data is removed from the cache. In accordance with implementations of the present disclosure, a QEP is re-ordered to provide a rQEP, in which producers and consumers of data within caches are called sequentially to make better reuse of the cached data. Implementations of the present disclosure decrease the execution time of queries, because more operators now find their data within caches, rather than fetching the data from comparatively slower main memory.

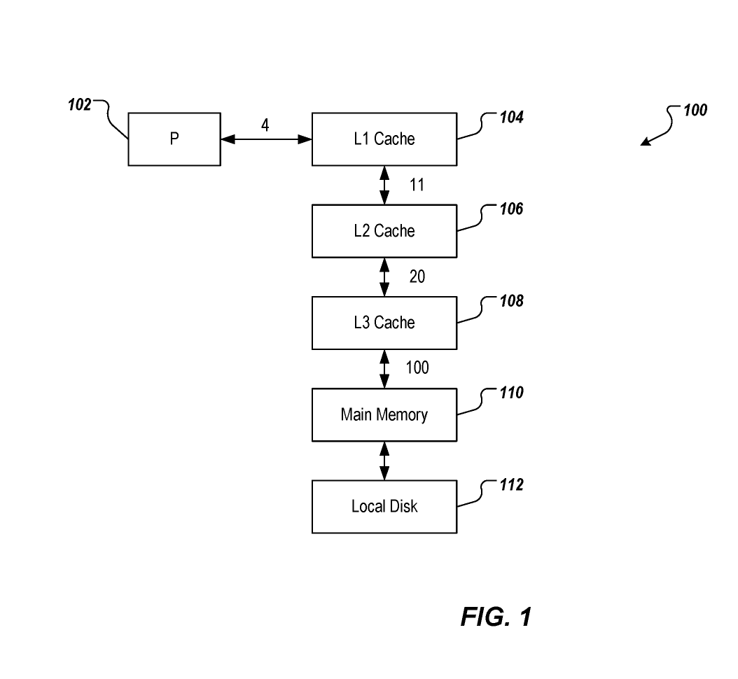

FIG. 1 depicts an example memory access path 100. The example memory access path 100 depicts a hardware resource pipeline for a processor 102 (e.g., a core) to access data from a memory architecture. In the depicted example, the memory architecture includes a multi-level cache having first, second, and third level caches 104, 106, 108, respectively, main memory 110, and disk-based memory 112. The example of FIG. 1 further depicts example latencies (e.g., in terms of average CPU cycles) between components. In some examples, the first and second level caches 104, 106 are on-chip caches, which are located on the processing core. Consequently, the first and second level caches 104, 106 have relatively lower latencies. In some examples, the third level cache 108 is shared by multiple processing cores. Consequently, the third level cache 108 has a higher latency (e.g., 20 CPU cycles) than the first and second level caches 104, 106. The main memory 110 is associated with a much higher latency (e.g., 100 CPU cycles). For example, if data requested by the processor 102 is not available in any of the first, second, and/or third level caches 104, 106, 108, the data is requested from the main memory 110, and ultimately from the highest latency disk-based memory 112, if also not in the main memory 110.

As described in further detail herein, implementations of the present disclosure provide rQEPs from respective QEPs, such that cache data reuse is increased. That is, and in terms of the example of FIG. 1, rQEPs are provided, such that data requested by the processor 102 is more often available from the first, second, and/or third level caches 104, 106, 108 thereby reducing the amount of CPU cycles required to perform operations. In other words, a rQEP will execute with more in-cache data than its underlying QEP, thereby improving (decreasing) the response time will for resolving the query. Even though the main memory 110 is a significant advance over the disk-based memory 112 (at least in terms of latency), the main memory 110 is still considered a bottle-neck in high-performance in-memory systems.

To illustrate implementations of the present disclosure, an example QEP and respective rQEP are discussed in further detail. The example QEP is associated with a benchmark query that can be processed in accordance with implementations of the present disclosure. Example benchmark queries can include queries provided in the TPC Benchmark H (TPC-H) provided by the Transaction Processing Performance Council of San Francisco, Calif. The TPC-H is a decision support benchmark that includes a set of business oriented ad-hoc queries (e.g., a set of benchmark queries), and concurrent data modifications. The TPC-H is described as being representative of decision support systems that examine large volumes of data, execute queries with a high degree of complexity, and provide answers to critical business questions. Although implementations are described in further detail herein with reference to an example TPC-H benchmark query, it is contemplated that implementations of the present disclosure can be realized using any appropriate query and respective QEP.

To illustrate implementations of the present disclosure, query number 11 (Q11) of the TPC-H will be discussed. In some examples, the TPC-H includes a set of 22 queries, where Q11 is entitled “Important Stock Identification Query,” and is executed to find the most important subset of suppliers' stock in a given nation. More specifically, Q11 finds, from scanning the available stock of suppliers in a given nation, all the parts that represent a significant percentage of the total value of all available parts, and the query result displays the part number and the value of those parts in descending order of value. To execute Q11, a QEP is provided. Listing 1, below, provides excerpts from the QEP of Q11:

Listing 1: Excerpts of QEP for TPC-H Q11

| | |
|---|---|
| 1 | X_33 := calc.str (3 , 7, 0, 0, “GERMANY” , 25); |
| 2 | X_167 := calc.str ( 3 , 7, 0, 0, “GERMANY” , 25); |
| 3 | X_1 := sql.mvc ( ); |
| | ... |
| 24 | X_39 := sql.projectdelta (X_28 , X_31 , X_34, r1_62 , X_37); |
| 25 | (X_80 , r1_208 ) := algebra.join (X_79 , X_39); |
| 26 | X_55 := sql.bind (X_1 , “sys” , “partsupp ” , “ ps_supplycost” , 0); |
| | ... |
| 44 | X_24 := X_21; |
| 45 | (X_25, r1_46) := algebra.join (X_13, X_24); |
| 46 | X_27 := algebra.leftfetchjoin (X_25 , X_2); |
| 47 | (X_40 , r1_74) := algebra.join (X_27 , X_39); |
| 48 | X_65 := algebra.leftfetchjoin (r1_74 , X_64); |
| | ... |
| 79 | sql.rsColumn (X_108, “sys.” , “value” , “decimal” , 19 , 2 , |
| | X_107); |
| 80 | X_119:= io.stdout ( ); |

In accordance with implementations of the present disclosure, a profiling tool is used to determine the execution time of each line (operator) of a QEP. In some examples, the profiling tool is provided as an LLVM tool (e.g., LLVM pass). In some examples, executing the QEP for Q11 reveals that line 25 is associated with an execution time of approximately 65,000 milliseconds (ms), and that line 47 is associated with an execution time of approximately 53,000 ms, while the remaining lines are each largely associated with execution times of less than approximately 500 ms. Overall, it can be determined that lines 25 and 47 together account for approximately 99% of the total execution time for the QEP of Q11. Consequently, lines 25 and 47 can be determined to be time-consuming operators of the QEP.

In accordance with implementations of the present disclosure, one or more operators (lines) of a QEP are determined to be time-consuming operators, for which operator re-ordering is to be determined. In some examples, the execution time of each operator can be compared to a threshold execution time, and, if the execution time of an operator exceeds the threshold execution time, the operator is determined to be a time-consuming operator. In some examples, the threshold execution time can be determined based on the execution times of all of the operators of the QEP. As one example, the threshold execution time can be determined as a specified percentage over an average execution time for all operators of the QEP. For example, if the average execution time is approximately 2,000 ms, the threshold execution time can be provided as 50% over the average execution time (e.g., 3,000 ms), such that any operator having an execution time over 3,000 ms is determined to be a time-consuming operator.

The output of an operator is initially stored in cache, until ultimately being deleted from the cache. If the output is to be provided as input to a subsequent operator, it would be beneficial to access the output from cache before it is deleted from cache, and would have to be accessed from a higher-latency memory (e.g., main memory, disk-based memory). In accordance with implementations of the present disclosure, producers and consumers of data are re-ordered to be next to each other in the QEP, such so that, when the data is produced by the producer, the next consumer of that data should be executed before that data is flushed out of the cache.

Continuing with the example of Q11, because lines 25 and 47 are time-consuming operators, the respective results of lines 25 and 47 can be reviewed to determine whether the operators are memory-bound operators, where most of their execution time is spent in accessing data from the main memory. In some examples, subsequent operators (e.g., operators that respectively use the outputs of lines 25 and 47 as inputs) are re-ordered within the QEP to provide a rQEP. For example, the operator of line 47 can be moved next to the second-most time consuming operator at line 25. For example, the operator of line 25 is the producer of intermediate data that is utilized by the operator of line 47. Accordingly, if the operators of lines 25 and 47 are put in closer proximity to one another (e.g., one after the other in the QEP), the data generated by line 25 would still be in the cache. In this manner, the operator of line 47 would have more cache hits (e.g., data retrieval from the cache), and response time for executing the query would become faster.

To achieve this, the consumers and producers of data in the QEP need to be determined. As described in further detail below, implementations of the present disclosure provide a profiling tool for discerning consumers and producers of data in QEPs. With continued reference to the example above, it can be determined that, in order to run the operator of line 47, the object X_39 is required as input, which is generated just before the operator of line 25. It can also be determined that a second input to the operator of line 47 is the object X_27, which is provided based on an object X_21, as shown in lines 44, 45, and 46 of Listing 1. It is also determined that the object X_21 is produced before line 25. Consequently, the operators of lines 44, 45, 46, and 47 can be re-ordered to occur after the operator of line 25 to provide a rQEP. Listing 2, below, provides excerpts from an example rQEP of Q11:

Listing 2: Excerpts of rQEP for TPC-H Q11

| | |
|---|---|
| 1 | X_33 := calc.str (3 , 7, 0, 0, “GERMANY” , 25); |
| 2 | X_167 := calc.str ( 3 , 7, 0, 0, “GERMANY” , 25); |
| 3 | X_1 := sql.mvc ( ); |
| | ... |
| 24 | X_39 := sql.projectdelta (X_28 , X_31 , X_34, r1_62 , X_37); |
| 25 | (X_80 , r1_208 ) := algebra.join (X_79 , X_39); |
| 26 | ... |
| 27 | X_24 := X_21; |
| 28 | (X_25, r1_46) := algebra.join (X_13, X_24); |
| 29 | X_27 := algebra.leftfetchjoin (X_25 , X_2); |
| 30 | (X_40 , r1_74) := algebra.join (X_27 , X_39); |
| 31 | ... |
| 32 | X_55 := sql.bind (X_1 , “sys” , “partsupp ” , “ ps_supplycost” , 0); |
| ... | |
| 81 | sql.rsColumn (X_108, “sys.” , “value” , “decimal” , 19 , 2 , |
| | X_107); |
| 82 | X_119:= io.stdout ( ); |

The rQEP for TPC-H Q11 was evaluated and an improvement in cache locality was shown. More particularly, evaluation of the rQEP for TPC-H Q11 revealed a reduction in cache misses from 3,669,598, using the QEP before re-ordering, to 2,270,658 using the rQEP. This is a decrease of 1,398,940 cache misses. Accordingly, the rQEP enables more accesses to be served from the cache, relative to the QEP, which improves the throughput of query execution engine by an order of magnitude.

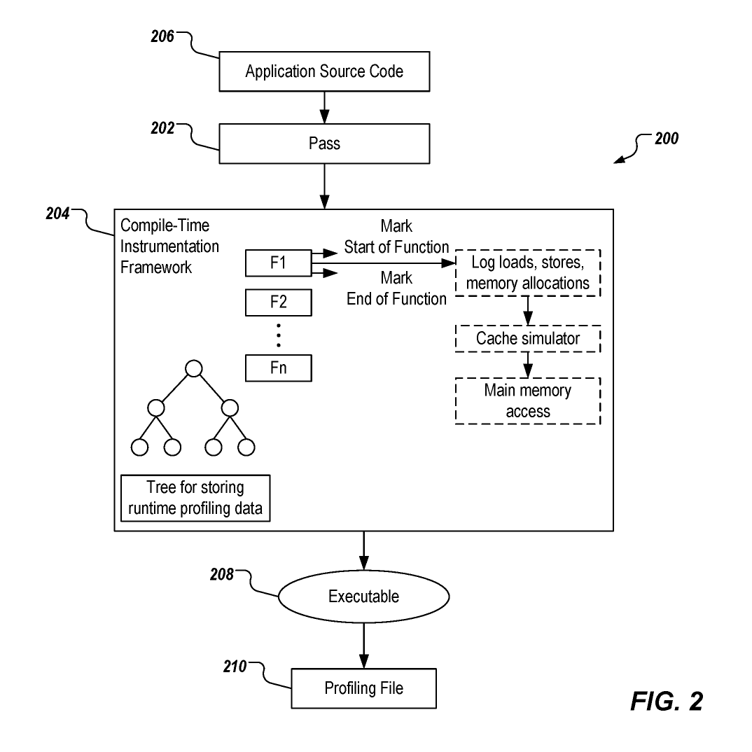

FIG. 2 depicts an example architecture 200 to profile QEPs in accordance with implementations of the present disclosure. In the depicted example, the example architecture 200 includes a pass 202 (e.g., an LLVM pass), and a compile-time instrumentation framework 204. In some examples, the pass 202 receives application source code 206 (e.g., source code of the application that is to be profiled), and provides executable code 208. In some examples, the pass 202 compiles the source code and adds instrumentation code to provide the executable code 208. In some examples, the instrumentation code includes instructions to profile the application during execution (e.g., objects, sizes, loads/stores of allocations).

In some examples, the executable code 208 is provided as bit-code (e.g., machine-readable code) and is executed by the compile-time instrumentation framework 204 to provide a profiling file 210, as described in further detail herein. In some examples, the profiling file 210 provides, for each operator of an executed QEP, execution time, cache accesses, cache misses, cache evictions, and main memory accesses.

In further detail, the instrumented executable code 208 can be executed to perform queries. During execution of the instrumented executable code 208, all loads and stores performed by the application (e.g., object reads/writes) are collected, and are passed to a cache simulator to identify accesses that go through to main memory (e.g., main memory traffic). For example, a QEP can be executed and, for each operator of the QEP, the following example information can be determined: execution time, cache accesses, cache misses, cache evictions, and main memory accesses. In some examples, the data of the profiling file is used to identify time-consuming operators that are memory-bound, as well as consumers and producers to enable re-ordering of the QEP to provide a rQEP.

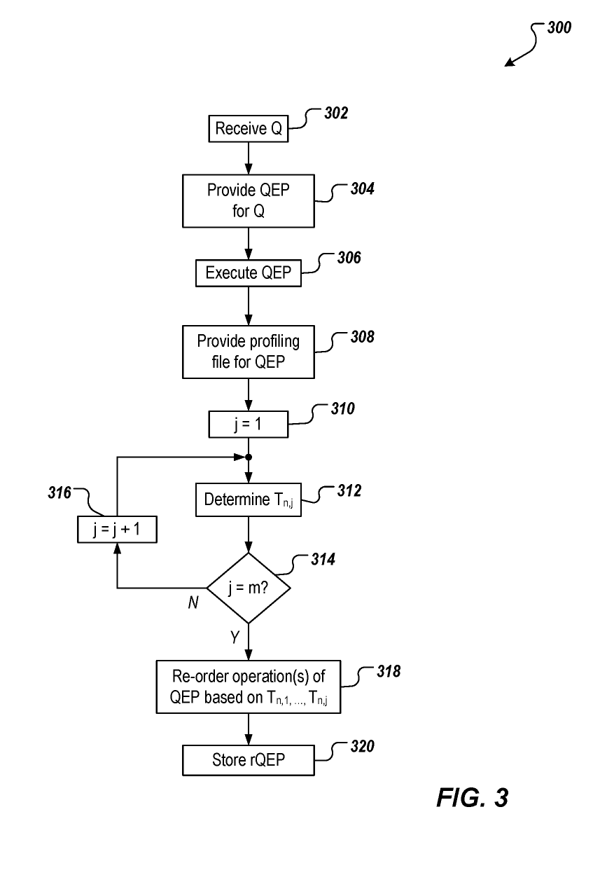

FIG. 3 depicts an example process 300 that can be executed in accordance with implementations of the present disclosure. In some implementations, the example process 300 may be performed using one or more computer-executable programs executed using one or more computing devices.

A query Q is received (302). For example, a query (e.g., SQL query) can be submitted using an application. In some examples, the application interacts with an in-memory database to provide a result to the query. A QEP is provided for the Q (304). In some examples, the QEP is pre-stored in memory, and is retrieved from memory based on the Q. In some examples, the QEP includes a plurality of operators provided in respective lines L. For example, the QEP can include lines L₁, . . . , Lₘ, each line being associated with a respective operator (e.g., P₁, . . . , Pₘ). In some examples, the operators of all lines L₁, . . . , Lₘ are performed to provide the query results. In some examples, the operators of lines L₁, . . . , Lₘ, (where x is an integer that is greater than zero and less than m−1) to provide an intermediate result. In some examples, a result of an operator (producer) of a line L₁, . . . , Lₘ₋₁, is an intermediate result that is provided to an operator (consumer) of a subsequent line (e.g., L₂, . . . , Lₘ), and the result of the operator of the last line Lₘ is provided as the query result.

The QEP is executed (308). For example, operators of the QEP are executed in line order (e.g., beginning with L₁) to incrementally provide respective intermediate results. In some examples, the QEP is executed as described above with reference to FIG. 2, and a profiling file is provided (308).

A counter j is set equal to 1 (310). Using the profiling file, an execution time (T_{n,j}) is determined for an executed line Lⱼ (312). In some examples, T_{n,j} is the time required to execute the operator Pⱼ of Lⱼ. In some examples, T_{n,j} is determined as a difference between a start time of the operator Pⱼ, and an end time of the respective operator Pⱼ. In some examples, a number of cache accesses (Cⱼ) is determined as LLCₕᵢₜₛ (e.g., hits to the LLC cache). In some examples, a number of main memory accesses is determined based on Cⱼ and a number of LLC writeback operations (LLC_{writebacks}). In some examples, LLC writeback operations are write operations going from the LLC to the main memory. The following example relationship can be used to determine Mⱼ, where μ is the total number of memory accesses:

M=(μ−LLCₕᵢₜₛ)+LLC_{writebacks}

It is determined whether the counter j is equal to m (314). In other words, it is determined whether all lines L of the QEP have been executed and respective times Tₙ determined. If j is not equal to m, j is incremented (316), and the example process loops back to consider the next line of the QEP.

If j is equal to m, one or more operations of the QEP are re-ordered based on the times T_{n,1}, . . . T_{n,j} to provide a rQEP (318). For example, one or more time-consuming operators are identified based on respective times, and producers/consumers of input and intermediate results used in the time-consuming operators are determined. For example, and as described above, each time Tₙ can be compared to a threshold, and if a time exceeds the threshold, the associated operator can be identified as a time-consuming operator. In some examples, one or more operators are re-ordered within the QEP to move consumers closer to producers, and ensure that other operators are not affected by the re-ordering. In some examples, it can be the case that no re-ordering of operators is to be conducted. In such cases, no operators are re-ordered, and the rQEP is identical to the QEP. The rQEP is stored (320). For example, the rQEP is stored in computer-readable memory, such that they are accessible at a subsequent call of Q, where, if Q is called again, the rQEP is retrieved from memory and is executed to provide a query result.

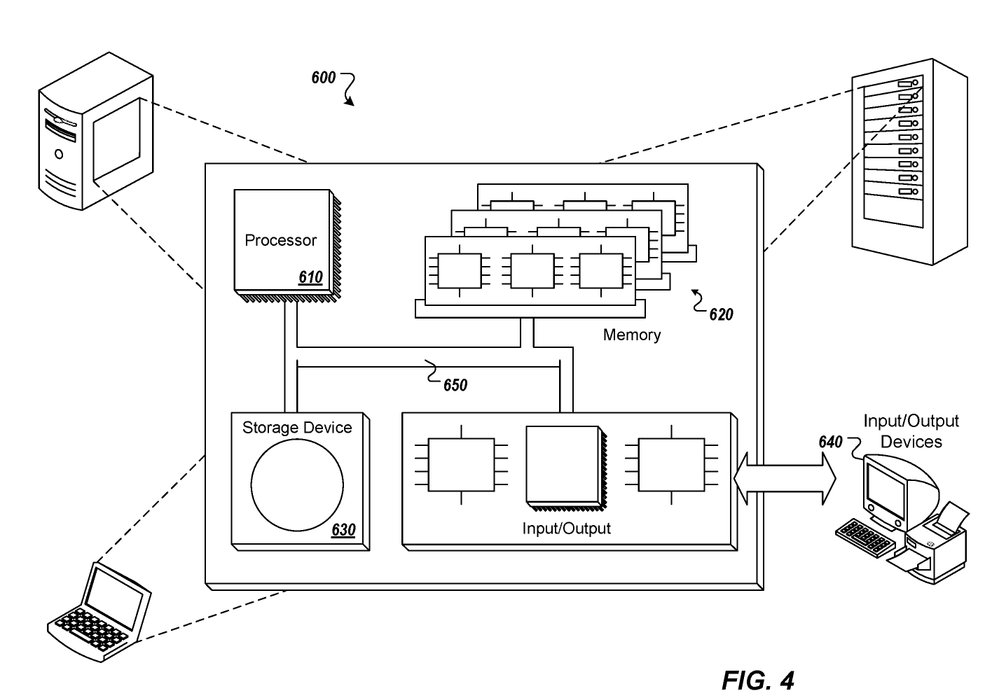

FIG. 4 depicts a schematic diagram of an example computing system 400. The system 400 may be used to perform the operations described with regard to one or more implementations of the present disclosure. For example, the system 400 may be included in any or all of the server components, or other computing device(s), discussed herein. The system 400 may include one or more processors 410, one or more memories 420, one or more storage devices 430, and one or more input/output (I/O) devices 440. The components 410, 420, 430, 440 may be interconnected using a system bus 450.

The processor 410 may be configured to execute instructions within the system 400. The processor 410 may include a single-threaded processor or a multi-threaded processor. The processor 410 may be configured to execute or otherwise process instructions stored in one or both of the memory 420 or the storage device 430. Execution of the instruction(s) may cause graphical information to be displayed or otherwise presented via a user interface on the I/O device 440.

The memory 420 may store information within the system 400. In some implementations, the memory 420 is a computer-readable medium. In some implementations, the memory 420 may include one or more volatile memory units. In some implementations, the memory 420 may include one or more non-volatile memory units.

The storage device 430 may be configured to provide mass storage for the system 400. In some implementations, the storage device 430 is a computer-readable medium. The storage device 430 may include a floppy disk device, a hard disk device, an optical disk device, a tape device, or other type of storage device. The I/O device 440 may provide I/O operations for the system 400. In some implementations, the I/O device 440 may include a keyboard, a pointing device, or other devices for data input. In some implementations, the I/O device 440 may include output devices such as a display unit for displaying graphical user interfaces or other types of user interfaces.

The features described may be implemented in digital electronic circuitry, or in computer hardware, firmware, software, or in combinations of them. The apparatus may be implemented in a computer program product tangibly embodied in an information carrier (e.g., in a machine-readable storage device) for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, application-specific integrated circuits (ASICs).

To provide for interaction with a user, the features may be implemented on a computer having a display device such as a cathode ray tube (CRT) or liquid crystal display (LCD) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a local area network (LAN), a wide area network (WAN), and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method executed by one or more processors, the method comprising:
receiving, by the one or more processors, a query from an application;
providing, by the one or more processors, a query execution plan (QEP) associated with the query, the QEP comprising a plurality of operators executed in a first order to provide a query result, one or more operators of the plurality of operators requiring input from computer-readable memory;
determining, by the one or more processors, an execution time for each operator in the plurality of operators;
re-ordering at least one operator of the plurality of operators to provide a re-ordered QEP (rQEP) based on a respective execution time, the rQEP comprising the plurality of operators executed in a second order to provide the query result; and
storing the rQEP in computer-readable memory.

2. The method of claim 1, wherein re-ordering at least one operator comprises:
identifying an operator as a time-consuming operator, the operator providing an intermediate result that is provided as input to the at least one operator; and
moving the at least one operator relative to the operator, such that a number of operators between the operator and the at least one operator is reduced.

3. The method of claim 2, wherein the at least one operator is moved relative to the operator, such that the number of operators between the operator and the at least one operator is reduced to zero.

4. The method of claim 1, wherein during execution of the QEP, the at least one operator receives input data from non-cache memory.

5. The method of claim 1, wherein during execution of the rQEP, the at least one operator receives input data from a cache.

6. The method of claim 1, wherein execution of the rQEP results in fewer cache misses than execution of the QEP.

7. The method of claim 1, further comprising:
receiving source code of the application;
providing an instrumented application that includes the source code and instrumentation code, the instrumented application comprising at least one instruction for profiling the plurality of operators;
executing the instrumented application to process the QEP to provide a profiling file, the profiling file indicating, for each operator in the plurality of operators, respective start times and end time; and
for each operator in the plurality of operators, determining a respective execution time based on a respective start time and a respective end time.

8. A non-transitory computer-readable storage medium coupled to one or more processors and having instructions stored thereon which, when executed by the one or more processors, cause the one or more processors to perform operations comprising:
receiving a query from an application;
providing a query execution plan (QEP) associated with the query, the QEP comprising a plurality of operators executed in a first order to provide a query result, one or more operators of the plurality of operators requiring input from computer-readable memory;
determining an execution time for each operator in the plurality of operators;
re-ordering at least one operator of the plurality of operators to provide a re-ordered QEP (rQEP) based on a respective execution time, the rQEP comprising the plurality of operators executed in a second order to provide the query result; and
storing the rQEP in computer-readable memory.

9. The computer-readable storage medium of claim 8, wherein re-ordering at least one operator comprises:
identifying an operator as a time-consuming operator, the operator providing an intermediate result that is provided as input to the at least one operator; and
moving the at least one operator relative to the operator, such that a number of operators between the operator and the at least one operator is reduced.

10. The computer-readable storage medium of claim 9, wherein the at least one operator is moved relative to the operator, such that the number of operators between the operator and the at least one operator is reduced to zero.

11. The computer-readable storage medium of claim 8, wherein during execution of the QEP, the at least one operator receives input data from non-cache memory.

12. The computer-readable storage medium of claim 8, wherein during execution of the rQEP, the at least one operator receives input data from a cache.

13. The computer-readable storage medium of claim 8, wherein execution of the rQEP results in fewer cache misses than execution of the QEP.

14. The computer-readable storage medium of claim 8, wherein operations further comprise:
receiving source code of the application;
providing an instrumented application that includes the source code and instrumentation code, the instrumented application comprising at least one instruction for profiling the plurality of operators;
executing the instrumented application to process the QEP to provide a profiling file, the profiling file indicating, for each operator in the plurality of operators, respective start times and end time; and
for each operator in the plurality of operators, determining a respective execution time based on a respective start time and a respective end time.

15. A system, comprising:
a computing device; and
a computer-readable storage device coupled to the computing device and having instructions stored thereon which, when executed by the computing device, cause the computing device to perform operations comprising:
receiving a query from an application;
providing a query execution plan (QEP) associated with the query, the QEP comprising a plurality of operators executed in a first order to provide a query result, one or more operators of the plurality of operators requiring input from computer-readable memory;
determining an execution time for each operator in the plurality of operators;
re-ordering at least one operator of the plurality of operators to provide a re-ordered QEP (rQEP) based on a respective execution time, the rQEP comprising the plurality of operators executed in a second order to provide the query result; and
storing the rQEP in computer-readable memory.

16. The system of claim 15, wherein re-ordering at least one operator comprises:
identifying an operator as a time-consuming operator, the operator providing an intermediate result that is provided as input to the at least one operator; and
moving the at least one operator relative to the operator, such that a number of operators between the operator and the at least one operator is reduced.

17. The system of claim 16, wherein the at least one operator is moved relative to the operator, such that the number of operators between the operator and the at least one operator is reduced to zero.

18. The system of claim 15, wherein during execution of the QEP, the at least one operator receives input data from non-cache memory.

19. The system of claim 15, wherein during execution of the rQEP, the at least one operator receives input data from a cache.

20. The system of claim 15, wherein execution of the rQEP results in fewer cache misses than execution of the QEP.
